(19) United States
(12) Patent Application Publication
(10) Pub. No.: US 2009/0293328 A1
(43) Pub. Date: Dec. 3, 2009

(54) Elastic bands

(76) Inventor: Duane Bull, Calgary (CA)

Correspondence Address: Charles Mass, Box 633 LCD 1, Medicine Hat, AB, T1A 7G6, CA

(21) Appl. No.: 12/154,960

(22) Filed: May 29, 2008

(51) Int. Cl. G09F 3/00

(52) U.S. Cl. 40/310; 40/299.01

(57) ABSTRACT

A stretchable readable band with markings used by Fast Food Outlets, Restaurants, Pubs, Bars, Social Functions and Personal Functions and Personal Use, in the daytime or at night.

The printing on the elastic band will be applied by either a washable pen or stamp so it can be washed and wiped off so the unit can be reused.

Each size unit will fit from closed position to a position 250% larger. This is accomplished by an increase of density of the elastomeric properties of the Adore.

Additional sizes of length and width are applicable and sizing of identification can be applied according to width and length.

This will assist in remembering ownership and products of the glass, cup or containers that would have non reflective or reflective elastic bands with printing for identification purposes.

### RELATED APPLICATIONS

The present application is related to Elastic Bands that are manufactured worldwide for all applications.

Patent # 20060207132A1, issued Sep. 21, 2006/2005013073A1, issued Aug. 11, 2005/007096544B2, issued Aug. 29, 2006/20040128877A1 issued Jul. 8, 2004.

### FIELD OF THE INVENTION

The present application is, as well, related to elastic bands with elastomeric differences regarded in the incorporation of a single band with the potential of printing, moulding and/or engraved word, number or symbol.

Please note that “improved elastic band” refers to multi elastomeric qualities.

The present invention relates to an elastic band used to personalize an item by stretching around and mounting lightly to mark a container, object, or a glass or a cup. This permits the user to know whose item, glass or cup belongs to them.

### BACKGROUND OF THE INVENTION

Ever since the invention of the elastic band the goal has been to increase the efficiency and uses for the elastic band.

When a person is using a glass, cup or any type of container, it can be marked for identification for the person it is used by and the substance inside said article.

The problem with all these examples is their inability to provide multi functional which are used in multipurpose functions.

Commercial Business's, private functions and home use all these could be covered with this applicable unit. Servers could mark the drinks with the name of the person who he or she is serving with what is in the glass. The chance of making an error is zero. It is therefore an object of the inventor to provide assistance so the marked personal glass or cup remains with that person whose identification is on that glass, cup or container.

It is another object of the inventor, that if a person having a germ that this would restrict this to be transmitted to the next person at personal home functions.

The names to be marked on this Invention would be done with the use of a washable marker

It is another object of the Invention; it could be used on marking stored materials in jars or containers so the Commercial or Household knows what is in that said container.

It is another object of the Invention; it could also assist on grip when carrying the object of a glass, cup or container with the markings of what is in the glass, cup or container.

It is another object of the Invention to be in multiple colors to give personal reference, a color for a specified unit, person or substance in the container.

It is another object of the Invention to be printed with a washable pen or stamp so the said bands can be reusable.

### SUMMARY OF THE INVENTION

In accordance with the present inventions, there is provided an elastic band, Non Reflective or Reflective, equipped with Markings to help separate, organize and mark all necessary products inside the said glass, cup or container.

The entire elastic defined named “Bull's Band It” will be in multiple lengths and will stretch to accommodate different sizes of glasses, cups or containers. The stretch will be for a certain sized distance, so as not to distort the name or the description written on it and it will remain readable.

The entire band is constructed of a durable, mouldable elastic, non-reflective or reflective material shaped in a circular form.

This unit is to organize all the said glasses, cups or containers which are used by servers for commercial or personal use at home.

### BRIEF DESCRIPTION OF DRAWINGS

A complete understanding of the present invention may be obtained by reference to the accompanying drawings, when considered in conjunction with the subsequent, detailed descriptions, in which:

FIG. 1 is a right top perspective view of an improved elastic, non reflective or reflective, identification band is a closed position.

FIG. 2 is a perspective view of a stretched elastic, non reflective or reflective, identification band, still readable identification on the said glass, cup or container.

FIG. 3 is an exploded perspective view of the identification elastic band in an applicatory action of installation.

FIG. 4 is a perspective view of an improved elastic band adjustable with identification for different sizes of glasses, cups or containers.

FIG. 5 is a perspective view of an improved elastic band functioning as an increase of surface to surface friction creating and ease of grip for the user.

### DESCRIPTION OF THE PREFERRED EMBODIMENT

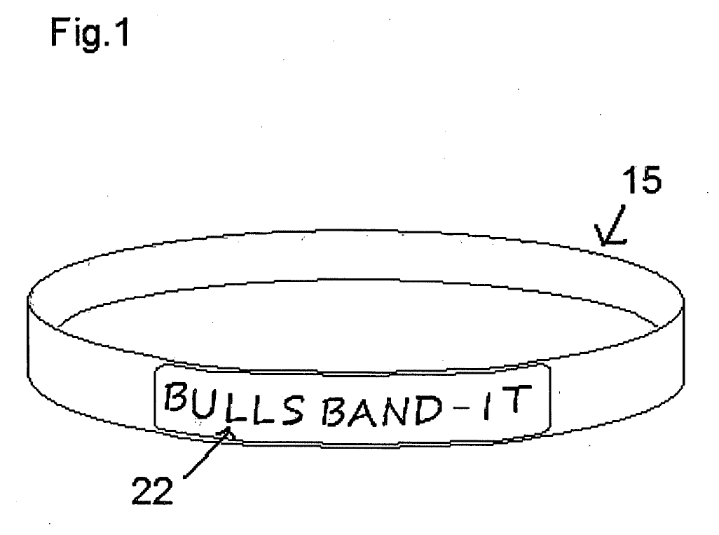

FIG. 1 is a right top perspective view of an improved elastic band, 15, in closed position displaying the identification. 22.

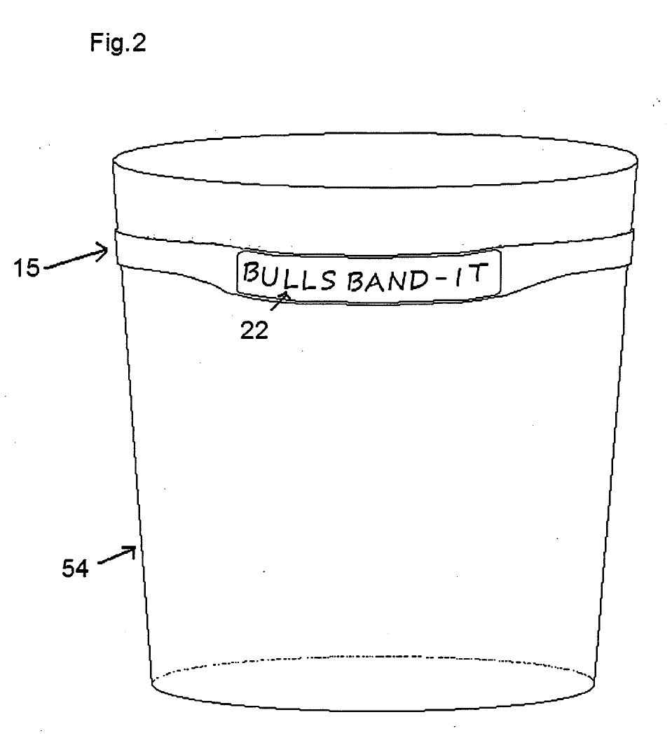

FIG. 2 is an exploded perspective view of an external, stretched elastic band, 15, non reflective or reflective, around an article. 54.

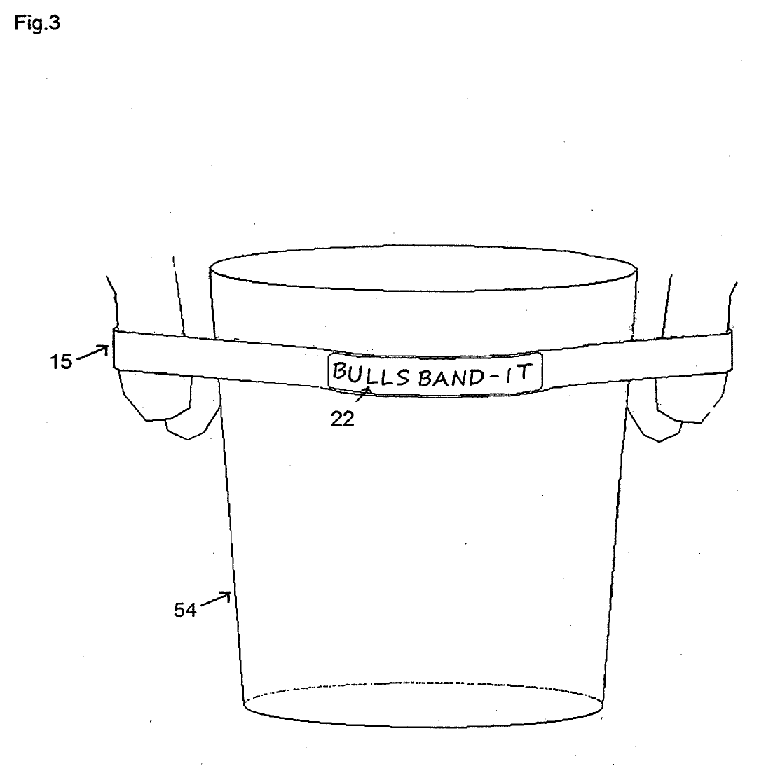

FIG. 3 is an exploded perspective view of an improved elastic band, 15, in the applicatory action of installation.

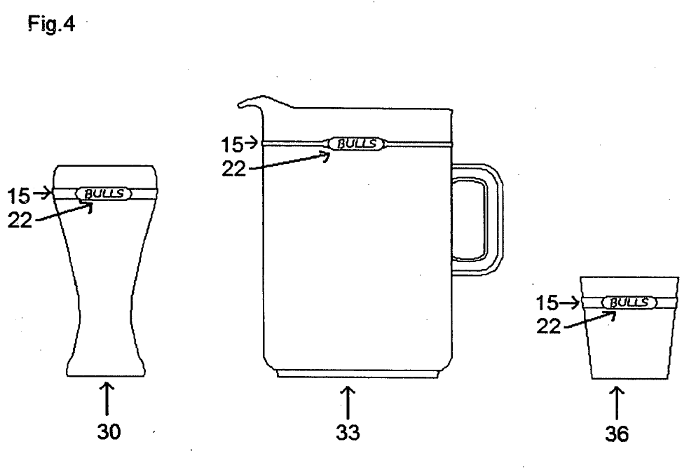

FIG. 4 is a perspective view of an improved elastic band, 15, adjustable with identification, 22, for different sizes of applicable glasses, 30, cups, 36, pitcher, 33.

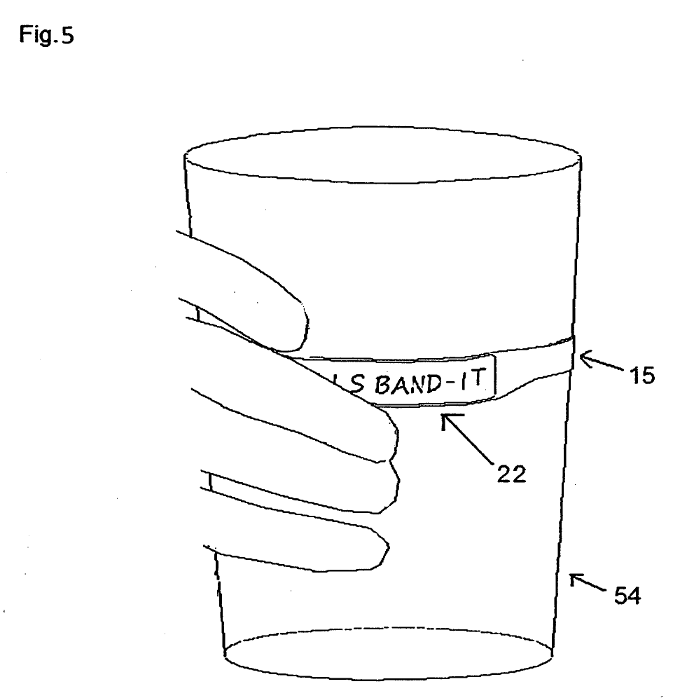

FIG. 5 is a perspective view of the “Bull's Band It” elastic with identification, 22, assisting in the action of gripping.

Referring now to FIG. 1, in a preferred embodiment of the invention as an improved identification band. 22.

Referring now to FIG. 2, in a most preferred embodiment of the invention the moulded identification elastic band, non reflective or reflective, slid across and showing attached to a said article, such as a glass, cup or container. 54.

This improved invention could have multiple descriptions on markings on the attached identification 22, non reflective or reflective elastic band. 15.

This ink will be erasable for multiple uses and/or applied by a stamp or written with a washable ink pen.

Referring now to FIG. 3 in a most preferred embodiment of the present invention is the ease of application to given purpose.

Referring now to FIG. 4 in a most preferred embodiment of the present invention showing the multiple size use without distortion of the ability to read the identification marks.

Referring now to FIG. 5 in a most preferred embodiment of the present invention detail is shown with this unit could help for grip to handle, to empty or weighted glasses, cups or containers which do not have handles.

Since the modifications and changes varied to fit particular operating requirements and environment will be apparent to those skilled in the art, the invention is not considered limited to the example chosen for purposes of disclosure, and covers all changes and modifications which do not constitute departures from the true spirit and scope of the invention.

Having thus described the invention, what is desired to be protected by the Letter Patent is presently appended claims.

What is claimed is:

1. An improved elastic band used for identification purposes of the user, comprising:
means for assisting on memory of the server using this article to make remembering dozens of peoples' names and also what was poured into a glass, cup or container, holding a liquid or dry product.
means for applying a name of a person for ease of returning identical item to that said person.
means for applying a mane of substance in the said glass, cup or container used by a commercial and/or home use.

2. The improved elastic band in accordance with claim 1, wherein said means for photoluminescence fluorescent materials for use in the dark to read the name of the person or substance in the glass, cup or container.

3. The improved elastic band in accordance with claim 1 where said means for the stretch of this improved elastic named band to be applied to different size articles such as glasses, cups or containers. When stretched to a certain size the distortion of the readable name of person or substance remains readable by any person handling the units.

4. The improved elastic band in accordance with claim 1 wherein said means for the color.
All colors are applicable to the improved name elastic band, including photoluminescence florescent colors for reading in the dark.

5. The improved elastic band in accordance with claim 1 wherein said means for the size. One size will fit multiple units from closed position to the stretched open position for proper identification for proper identification,
Second, Third and Forth and addition units are in configuration to the sizes, small, medium and large of glasses, cups or containers for a closed and stretched position.

6. The improved elastic band in accordance with class 1, when is said means for material, isoprene rubber and latex, synthetic rubber artificially made polymer.
All materials for all types of elastic bands which printing by hand or stamp.
Phosphorescence added to colors to produce a fluorescent that the name of person or product can be identified by the end user.

7. The improved elastic band in accordance with claim 1, where is said means for Fire Rate Bands used for identification under high heat extreme conditions and being able to be read stating positions of people on a desired position.
